(19) United States
(12) Patent Application Publication
(10) Pub. No.: US 2006/0101877 A1
(43) Pub. Date: May 18, 2006

(54) Safety box for storing personal valuables, a safety anchor for securing the safety box and safety fasteners for securing a variety of other objects

(76) Inventors: Henrik Orum, Vildrosevej (DK); Ann-Marie Orum, Vildrosevej (DK)

Correspondence Address: HARNESS, DICKEY & PIERCE, P.L.C., P.O. BOX 8910, RESTON, VA, 20195, US

(21) Appl. No.: 10/524,594

(22) PCT Filed: Aug. 15, 2003
(86) PCT No.: PCT/DK03/00546

§ 371 Date: Sep. 16, 2005

(30) Foreign Application Priority Data
Aug. 15, 2002 (DK) PA 2002 01213
Oct. 16, 2002 (DK) PA 2002 01589
Jan. 20, 2003 (DK) PA 2003 00057

(51) Int. Cl. F16B 41/00

(52) U.S. Cl. 70/231

(57) ABSTRACT

A safety-box is provided that can be attached to a hard-to-move object and used for safe and convenient storage of personal valuables in public places such as on beaches, on camping grounds, at festivals, etc. Also provided is a device, termed a safety-anchor, which can function as a hard-to-move object for securing a safety-box. Finally, the invention provides safety-fasteners that can be used to efficiently and conveniently secure a diversity of indoor and outdoor objects and items against theft and unauthorised removal.

### INTRODUCTION

The invention provides a box, termed a safety-box, which can be physically attached to a hard-to-move-object and used for safe and convenient storage of personal valuables on beaches and other public or semi-public places.

Furthermore, the invention provides a device, termed a safety-anchor, which in a first aspect can be easily installed into the ground but which is very difficult to remove for anyone but the authorised user and consequently can serve as a hard-to-move object for securing the safety-box or other devices.

In another aspect of the invention, the principle behind the safety-anchor is used to provide novel safety-fasteners that can be used to secure a diversity of objects against unauthorised removal. The safety-fasteners of the invention combine the attributes of ordinary fasteners with the ability to be converted into a safety-fastener by any of a number of very simple operations. Fasteners based on the invention can thus be mounted as ordinary fasteners using a variety of standard tools and, once mounting is satisfactory, turned into a safety-fastener that cannot be easily removed by unauthorised persons.

Finally, the invention provides a special safety-fastener, termed a lock-safety-fastener, which can be used to effectively secure a diversity of objects against unauthorised removal whilst at the same time allowing easy attachment/detachment of the valuable object by the authorised user.

### BACKGROUND

People typically carry an assortment of valuables such as cash, credit cards, cellular phones, watches, electronic devices, etc., i.e. valuables that are attractive for thieves. Although such valuables can be stolen even when located on the owner e.g. in the owners pocket, the risk of theft increases with the distance between the valuables and the owner, e.g. when the valuables are placed in a handbag, put into an unlocked drawer, left in overcoats, etc. In particular, there is a risk of theft when such separation occurs in public or semi-public places such as restaurants, offices, etc. A particular problematic place to secure valuables for owners is a crowded beach in the summer season as such valuables are either impractical or impossible to carry or difficult to constantly monitor when performing most beach activities such as sun-tanning, bathing, playing games, etc.

Obviously, individuals/companies that provide services to beach guests such as renting sun-beds, sun-parasols, etc. (“renters”) could address the problem of safe-storage on beaches by traditional approaches such as providing a centrally located safe-storage facility similar to that found in railway stations, etc. This solution, however, is not practical on beaches because valuables such as a CD, a Walkman, a cellular phone, sun-glasses, cash, etc. which the owner chooses to bring to the beach must be readily and repetitively available throughout the day to fulfil their objective. On beaches therefore, useful safe storage must be provided at, or close to, the site where the owner chooses to lie (on-site storage).

In theory, such on-site storage could be provided by distributing traditional iron safes, like the ones commonly found in hotel rooms, throughout the beach. Obviously, however, a number of factors makes this solution both highly impractical and commercially unsound such as for instance the cost of such safes, the considerable difficulties in distributing and collecting them at sun-up and sun-set (on those beaches where permanent fixation of large numbers of safes would either not be allowed or desirable) and the general design and choice of materials of said safes not being optimised for use in a beach environment.

In fact, as described below, and in the following section, safe-storage on beaches presents a range of special problems (some of which are seemingly opposing) for both the beach guest (user), manufacturer and renter that traditional approaches do not address—a fact which is forcefully underlined by the lack of safe-storage means on most beaches. For instance, the safe-storage device,
1. should be easy to place/provide close to, or preferentially at, the site where the user chooses to lie yet be very difficult to remove for un-authorised persons without being noticed by the user or other people on the beach and preferably be very awkward to escape with if chased.
2. should be difficult to break into by un-authorised persons whilst at the same time enable moderately easy “authorised break-in” in cases where the user has lost the means to open the safety-box the intended way.
3. should be cheap to manufacture yet have a reasonable lifetime under the conditions to which it is exposed.

Furthermore, as devices, which facilitate safe storage on beaches, in many cases, are likely to become subjects of a beach rental operation alongside sun-beds and sun-parasols, such devices must be logistically simple to operate in large numbers for a renter.

Given the above, the present invention provides a device, termed a safety-box, which comprise the functionalities required for storing personal valuables e.g. in a beach environment and which can be secured against inconspicuous and easy removal by unauthorised persons by physical attachment to a hard-to-move object located at the position where the user chooses to lie. e.g. a sun-bed.

It is a further object of the present invention to provide very large safety-fasteners, termed safety-anchors, which are easy to install/uninstall into soil, sand etc. for the user but very difficult to remove for un-authorised person without attracting significant attention. As such, a safety-anchor can function as a hard-to-move attachment point for a safety-box instead of a sun-bed. Likewise, the safety-anchor can serve as a portable attachment points for securing a variety of other objects and devices against theft and unauthorised removal in public and semi-public places.

Devices that can be anchored into—and removed from—the ground by a rotating movement similar to the safety-anchor described herein and used as an attachment point for a variety of different devices are known, such as for instance the eartworm™ (www.theearthworm.com) and the beach-anchor (www.beachstuf.com). Contrary to the safety-anchor of the present invention, however, none of these devices include features that offer protection against unauthorised removal. As such, they are not useful as attachments points for valuable items that are attractive objects for thieves.

In yet another aspect of the invention, the principle behind the safety-anchor is used to provide novel safety-fasteners that can be used to secure a diversity of objects against unauthorised removal. Until now, fasteners that provide such functionality have been based on either of the two following approaches.

One approach has been to design fasteners that handles normally but requires the use of special/individualised tools that are not broadly available. Fasteners based on this principle are commonly used as a means of for instance securing wheels on automobiles against theft. Since such safety-fasteners can be both fastened and removed with equal ease by anyone who has the required tool, the protection they offer against theft is obviously limited.

The other approach has been to design the safety-fastener such that it can use standard tools for mounting but such that it cannot be removed by the same means that was used to fasten it. Such safety-fasteners carry a slot that only allows clock-wise rotation thereby preventing the fastener from being removed once fastened. Whereas fasteners based on this principle, offers better protection against theft than safety-fasteners that handles normally but requires special tools, it suffers from a number of disadvantages that has limited their use. Firstly, the uni-directional design of the fastener slot complicates fastening as the mounting tool easily “slips out” of the slot. Secondly, any mistakes that occur during mounting and which requires full or partial removal of the safety-fastener are extremely difficult to correct. Thirdly, the unidirectional principle, for all realistic purposes, is limited to the standard fastener slot which is increasingly being phased out as more user friendly designs such as countersunk fastener-heads for Allen keys, Parker's fastener drivers etc. have appeared. Also, the unidirectional principle is not applicable to bolts with hexagonal blot heads for spanners and monkey wrenches.

Given the above, it is a principal object of the present invention to provide safety-fasteners that handles as normal screws/bolts i.e. allows bi-directional rotation, can be fastened by a variety of contemporary fastening tools and which at the same time provides substantial protection against unauthorised removal.

Finally, it is an object of the present invention to provide a special safety-fastener, termed a lock-safety-fastener, which can be used to effectively secure a diversity of objects against unauthorised removal whilst allowing easy attachment/detachment of the valuable object by the authorised user.

### DESCRIPTION OF THE INVENTION

It is an object of the present invention to provide a device, termed a safety-box, that facilitates safe and convenient storage of personal valuables in public places, such as for instance on beaches. In a first aspect of the invention a lock is provided that is useful for such a safety-box.

In theory, there are several different locks that can be used on a safety-box. For instance, the safety-box may be equipped with a traditional lock that can be operated by a dedicated instrument, such as for instance a key. Such a solution, however, suffers from a number of shortcomings that makes it unattractive. For instance, anyone who intended to make safety-boxes the subject of a rental business similar to the renting of sun-beds would find a solution based on a dedicated key for each safety-box logistically very complex to manage.

Furthermore, keys are impractical to carry on the beach for the user and may also be lost. As a lost key may be found by others and as such compromise safety, an owner that wishes to maintain maximal security of his/hers safety-box cannot simply replace a lost key with a spare key but must re-code the lock and make a new key. To a renter who needs to be particular concerned about the security of the safety-boxes that he rents to users, a lost key therefore invokes both expenses, potential loss of income and inconvenience.

To a renter, a key based solution would further require the holding of either dedicated spare keys, or a master key that opens all safety-boxes to allow users that have accidentally lost their key access to their valuables within a reasonable timeframe. The mere existence of such spare keys or master keys, however, would be severely worrying to the user as optimal safety requires that only he/she has the means to readily open his/hers safety-box (“user exclusive access”).

Such “user exclusive” access can be achieved by providing the safety-box with an electronic or mechanical code lock, which enables the user to operate the safety-box with a password of his/hers own choosing. To the user, this solution affords the security offered by a personal password known only to the user as well as the convenience of not having to carry any physical objects to operate the safety-box. Likewise, such a solution is practical to the renter as it would dispense with many of the above outlined problems associated with a key based solution.

Accordingly, in a preferred embodiment of the invention a combination lock for a safety-box is provided, said lock comprising
a lock effectuating means adapted to shift between a locked state and an unlocked state,
a code-entering means arranged to control shifting of the lock effectuating means from the locked state to the unlocked state upon entering a code, and
a lock actuation means adapted to actuate the code-entering means to accept and store a user-defined code upon receipt of a lock actuator,
   wherein the ability of the lock to shift between the locked and unlocked state is conditioned on the actuation of the lock.

Due to the fact that the ability of the lock to shift between the locked and the unlocked state is conditioned on the actuation, the lock supports rental services. As an example, in a situation wherein a large number of locks, e.g. associated with beach chairs with safety-boxes, are rented on an hourly or daily basis, the user can be provided with a lock actuator which is used to actuate the lock on one of the safety-boxes upon payment of a rental fee to a beach guard.

The lock effectuating means may be provided e.g. in the form of a locking element, ring, clamp bolt or similar mechanical device adapted to engage a corresponding recess or edge of a closure or frame therefore or which is adapted to operate in a padlock fashion.

The code-entering means may be provided in the form of a digital keyboard, one or more mechanical dials etc. and may comprise control means adapted, upon setting of the right code, to shift the lock from the locked state to the unlocked state.

Electronic or mechanical code locks are known from for instance safes in hotel rooms, offices and private homes. Since such safes are often left unattended for prolonged period of times such as hours, days or more their code locks must be sufficiently sophisticated to operate with complex codes that can withstand very lengthy code-breaking attempts or they must be fitted with “anti-tampering” features that for instance shuts down the lock, or activates a theft-alarm, if three or more erroneous codes are entered.

Whilst such sophisticated locks are necessary with traditional safes they are neither needed nor desired in a safety-box.

Firstly, thieves on beaches typically operate by a walk-by-and-grap approach at a point in time when the owner is inattentive. As such, a special feature of a useful lock for a safety-box is that it need not protect against break-in attempts for prolonged periods of time such as hours or days. In fact, a lock on a safety-box that offers as little as for instance 5 min. resistance to break-in is highly functional when, at the same time, the safety-box itself is very difficult to remove without attracting attention from either the user or other people on the beach.

Secondly, in contrast to sophisticated code locks on traditional safes it is desirable that a lock for a beach safety-box facilitates “authorised break-in” within a reasonable timeframe, to address the potential problem of its user becoming unable to open the safety-box the intended way, e.g. the user may forget his/hers password and as such be faced with the problem of how to retrieve his/hers valuables. Since the safety-box, for security reasons, must only be operable by the user with the proper code, the only option when the user forgets his/hers code is to systematically test all the possible codes that the lock can accommodate.

Thus, the code lock of the present invention is intended to be of low complexity to allow the user/renter to test the entire universe of possible codes within a reasonable time frame. In a preferred embodiment the code-lock is so designed that it may encompass from 50-1000 code combinations. A sample space of this size will ensure that it is not too easy and yet not too troublesome to try out all combinations. Depending on the type of code-entering means, it should be possible to open a lock within 10-30 minutes. A person skilled-in-the-art will appreciate that such a functionality can be provided by for instance the 3 or 4-digit mechanical code locks found on many suitcases, 3 or 4-digit code padlock or 3 or 4-digit electronic code-locks.

The preferred code lock of the present invention furthermore does not comprise any sophisticated “anti-tampering” features or activate an alarm in the process as this would impair or destroy the ability to test the entire universe of possible codes. As such, the code lock for the beach safety-box is far less expensive to manufacture than code locks for use with traditional safes.

In order to allow different users to subsequently use a lock, the lock should enable the user to redefine the code. This may be achieved e.g. by adapting the lock to accept a new code upon insertion of the actuator.

In order to ensure that no safety-boxes are left in a locked state, the lock may be adapted to shift from the locked state to its unlocked state upon removal of the actuator. The actuators may as an example be rented to the beach guests upon payment of a deposit which is paid back to the guest upon return of the actuator. At the end of the day, the possession of all available actuators proves to the responsible person, that no safety-boxes are left in a locked state.

The lock is preferably purely mechanical, i.e. it operates without power supply. However, it may be an advantage to provide an electrically powered lock wherein the user-defined code is maintained irrespective of power failure and re-powering.

A simple and yet reliable actuation of the lock may be provided by actuation means defining a key-hole for receiving a key with a specific exterior shape. The lock may be provided with a shape template which is interchangeable and which thus allows the owner of the lock to change the shape of the actuator frequently and thus to ensure liability of the lock. In order to allow maintenance of a plurality of locks, all locks may be provided with the same shape template and thus be adapted to activate with actuators of the same shape. It should be noted that the safety towards theft is ensured by the user defined code and therefore nothing hinders the use of actuators of the same shape.

According to an alternative embodiment, the actuation means and the actuators may co-operate to actuate the lock based on a specific weight of the actuator.

In order to provide a lock which is durable e.g. on a beach, it is an advantage to provide the lock in non-corrosive materials such as plastic.

As stated earlier, it is anticipated that the safety-box in many cases will become the subject of a rental business alongside sun-beds and sun-parasols. A particular objective of the invention, therefore, is to construct the safety-box in such a way that the user is encouraged to leave the safety-box in a condition where it is readily usable for a subsequent user. In other words, the design of the safety-box should be such that the user is encouraged not to leave the safety-box closed and with his/hers personal code still active at the end of the use period.

One means of achieving this is by making the function of the code-lock dependent on an instrument, which can be entrusted to the user by the renter against a deposit that strongly motivates the user to return the instrument to the renter at the end of the use period. This can be achieved by for instance designing the code-lock in such a way that it
requires for instance a pin, to be inserted into a position in the lock mechanisms which is accessible only when the safety-box is open
“activates” the lock to accept a user defined code upon insertion of the pin, and
disables the code upon removal of the pin.

As mentioned above, for security reasons, it is an advantage that the insertion point for the pin into the lock is only accessible when the safety-box is open, i.e. when the safety-box is available for use. This being the case, the pin can be made universal, i.e. one pin fits all safety-boxes, which is a major advantage to the logistics of handling multiple beach-safety-devices for the renter.

Activating pins, however, as all other items may be lost by the user and found by others or stolen. Although pins in unauthorised possession do not present any risk to the user of a safety-box as pins require access to the interior of the safety-box to work, it does, however, present a potential loss of income to the renter as holders of such unauthorised pins can operate an unoccupied safety-box without paying. Although, this is unlikely to become a problem in the short term for the individual renter—it may become troublesome in the long run as more pins are likely to get into unauthorised hands.

In a preferred embodiment of the safety-box, therefore, the code-lock is designed in such a way that it can be set by the renter to accept a number of different pins, such as for instance from 2 to 10 different pins, by a simple manual operation thus allowing the renter to “cleanse” his safety-box renting business by simply acquiring new pins.

In many cases, the renter is likely to charge the user a fee for using the safety-box. In such cases the renter can for instance deduct a rental fee from the deposit the user paid to initially obtain the pin when the user returns the instrument. In other cases, however, the owner may choose to provide the safety-box for free, such as for instance in hotels where sun-beds, sun-parasols, etc. are often provided to the guests free-of-charge. In such cases, a pin system to activate the code-lock is not optimal as the incentive to return the pin to the owner rests on the payment of an “encouraging” deposit. In a preferred embodiment of the invention, therefore, a code-lock is provided that in place of, and with the same functionality as a pin, is operable with a coin of enough value that the customer will want to retrieve it after end use.

In one preferred embodiment of the invention the code lock, which can be either a mechanical or electronic code lock, is built into the safety-box and is activated/deactivated by the insertion/removal of for instance a pin or a coin.

In another preferred embodiment the code-lock is provided as a separate item, such as for instance a code padlock. Such a design has the advantage that the safety-box will be cheaper to manufacture than a safety-box with an integrated code lock. Padlocks, however, are easily destroyed by cutting-tools and as such do not provide the same level of security against unauthorised break-in, per se, as a code lock that is built into the safety-box.

In a preferred embodiment of the invention, therefore, the safety-box is designed in such a way that the vulnerable parts of a code padlock are physically shielded against access by cutting-tools. As shown in FIG. 1, this can be achieved, by for instance designing the safety-box in such a way that the “vulnerable” part of the padlock is embedded in a groove or protected by a protrusion on the safety-box into which an effective cutting-tools cannot get access.

Although the safety-box has been described in the foregoing as a useful device on beaches it will be obvious to the reader that it can be used in a variety of situations where there is a need to secure small personal valuables against walk-by-theft such as for instance on camping-grounds or places where many people are assembled to attend for instance concerts or games.

According to a second aspect, the present invention relates to a beach chair comprising a safety-box with a closable cavity for storage of personal items. Preferably, the box is provided with locking means preventing opening of the box and preferably, locking means in the form of a combination lock as described above.

In order to protect the combination lock from sand and water, the code-entering part of the code-lock may be protected by a cover, which automatically falls down over the code-entering part of the code lock if not actively lifted.

In order to provide a simple and yet reliable system, the box may be provided with co-operating eyes or loops of a closing lid and the box for closing the lid with a combination padlock. However, according to a preferred embodiment, the combination lock is an integrated part of the chair and/or the box. Preferably, the actuator of the combination lock is inserted into and removed from the box from the inside of the box. In that way, no one but the user who knows the code has direct access to the actuator. According to one preferred embodiment, the actuator is inserted into the lock from outside the cavity and can only be removed from the lock from the inside of the cavity. In that way, all boxes on the beach may be left by the owner in a locked state. When a user rents an actuator, the actuator may be inserted into the lock of a box which is locked. After insertion of the actuator, the user is able to define his own code and to open the box. After use, the user removes the actuator whereby the lock changes to a locked state and when leaving the chair, the lid of the box falls back onto the box and a latch of the lock locks the lid.

In order to protect the valuables placed in the safety-box from moist and dirt, the safety-box may be provided with one or more ventilation openings for ventilation of the cavity. In a simple manner, the ventilation openings may be provided between the sidewall and the closure, e.g. by providing an upper part of the sidewall with an uneven edge so that the closure is prevented from sealing air-tightly against the sidewall. The ventilation opening(s) may be shielded towards impact of weather in particular towards impact of rain and sand.

In the bottom of the box, one or more drain openings for draining the cavity may be provided. In order to support valuables contained in the box on a dry surface, a grid for retaining the personal items in the box in a position between the opening and the grid may be provided.

In order to lead fluids to the drain opening(s) and thus to support in keeping the cavity of the box dry, the box may be provided with a bottom part which sloops downwards towards the drain opening.

In a preferred embodiment of the invention (see FIGS. 1 and 2), therefore, the safety-box is a simple device, which can be locked by the use of a code padlock, consisting of
a box (with holes to facilitate appropriate mounting on a sun-bed or a safety-anchor) and a lid, produced in either cheap plastic materials suited for beach conditions, such as those used for sun-beds, or thin metal plates which can be protected against the wet and salty conditions on a beach by a suitable protective layer such as for instance a paint,
a metal or plastic hinge-pin that serves to connect the lid (which carries half the hinge) to the box (which carries the other half of the hinge) in such a way that the box can be opened, and
a mount for securely attaching the safety-box physically to either a sun-bed or a safety-anchor in such a way that the beach-safety-box is functional and easily operable by the user.

Many of the valuables that the safety-box is intended to store, such as electronics and mobile phones, can suffer damage if exposed to water and sand. As such, it is a further objective of the invention that the safety-box is designed such that water and sand do not readily enter the interior, and/or are readily removed if they do. As shown in FIGS. 1 and 2, this can be achieved by for instance designing the safety-box in such a way that the lid significantly overhangs the box and such that the bottom of the box is slightly skewed downwards towards the centre where for instance one or more holes, slits, etc. of a suitable size provide an outlet for sand or water that has accidentally entered the interior. To provide a flat bottom on which the user can place his/hers valuables in such a skewed-bottom box a suitable horizontal grid, that will allow water and sand to pass through, can be placed above the bottom of the safety-box.

In another preferred embodiment of the invention the beach box is manufactured with an integrated code lock. In this situation it is of particular importance that the code-lock itself be protected from the abrasive action of water, moist, salt and sand.

When a mechanical code lock, that involves moving parts, is used in the safety-box such protection can be provided by using for instance non-corroding materials such as plastics or aluminium and/or by protecting the code-lock with for instance a cover-lid. Preferably, as shown in FIG. 3 this lid is constructed in such a way that it automatically falls down and protects the code-lock if not actively lifted by the user. Preferably, also, the code lock is placed on the side of the safety-box rather than on the top to secure as little as possible exposure to water, moist, salt and sand.

When an electronic code lock is used in the safety-box a continuous input of electric power, such as that provided by a battery, is needed to keep the code lock functional. Since, the proper function of both the power supply and the electronics in the code lock is sensitive to moist and water it is an aspect of the invention to use appropriately protected components, such as water and moist resistant connections between the battery and the electronic circuit and a water-resistant keyboard for the code-lock. A person skilled-in-the-art will appreciate that several means exist by which such water and moist protection can be achieved.

It is a further aspect of the invention to design the safety-box in such a way that the build-up of moist and/or water that may damage a mechanical code-lock, a power supply, the electronics in an electronic code lock or the users valuables is minimised. Build-up of water, of course, can be prevented by providing a water outlet in the bottom of the safety-box, as described in the foregoing. Build-up of moist on the other hand, requires proper aeration of the interior of the box. Such aeration can be achieved by providing the safety-box with air-inlets in the walls and/or the lid that in combination with the water draining out-lets in the bottom enables the air to circulate through the interior. Since undesired sand may also enter through such air-inlets it is a particular aspect of the invention to provide a design that facilitates aeration whilst minimising the risk of entry of sand. As shown in FIGS. 1-3, this can be achieved by for instance combining an oversize lid with air-inlets at the lid-box interface.

The power supply for an electronic code lock, of course, may be exhausted so that the code lock ceases to operate, i.e. cannot be opened by the user or anybody else. Whilst the probability of such incidences may be reduced by equipping the code-lock with an alarm to indicate low battery it obviously cannot be completely eliminated. To enable the authorised opening of the safety-box in such cases, whilst at the same time maintain safety for the user, it is a special objective of the invention that i) the code lock remembers the active user password even after power failure and that ii) the design of the safety-box enables the code lock to be re-powered by an external power supply. Such a re-powering capability can be provided by for instance inserting a power docking device, that can be accessed by an external power supply, between the internal power supply and the electronic circuits. A person skilled-in-the-art, however, will appreciate that the intended functionality can be obtained with other designs as well, which thus falls within the spirit of the inventions.

The safety-box is intended to be physically attached to a sun-bed or other hard-to-move objects such as a beach-anchor (see later). Such attachment, of course, can be achieved by for instance mounting it directly to the hard-to-move object or by linking it to the hard-to-move object through a metal chain that cannot be easily cut. Since, various openings to provide outlet of water and sand and inlet of air is desirable in a safety-box (as described above) and since the proper function of these features requires that the safety-box is appropriately orientated in space, the preferred attachment mode for a beach safety-box is by direct mount to the hard-to-move object and in such a way that it is elevated above the beach to prevent entry of water and sand and such that it can be easily operated by the user. The safety-box shown in FIGS. 1-3 is designed such that it can be easily mounted on the safety-anchor depicted in FIG. 4-7 or be physically attached through a separate mount to a beach chair (FIG. 2). A person skilled-in-the-art, however, will recognise that other types of mounts or other designs of the safety-box are possible without deviating from the spirit of the invention.

According to a third aspect, the invention relates to a safety-box similar to the box described above with relation to the beach chair. The box comprises fastening means provided with a fastened and a non-fastened state for releasable fastening of the box to peripheral objects such as a beach chair or to an anchoring device for fastening items to a beach.

In order to ensure that the box can not be removed by anyone but the user, the fastening means should be provided with a fastening and releasing control which is accessible only from the inside of the cavity. As an example, the fastening means may comprise a spring activated locking element engaging a corresponding locking member of a beach chair or a safety-anchor or similar items which are less easily removed from the beach. The spring activated locking element should be releasable from inside the cavity of the box so that the box can not be removed until it has been opened.

In order to ensure that the ventilation opening and draining opening of the box is turned upwardly and downwardly, respectively, the fastening means may be adapted to only allow fastening of the box to the beach chair in one specific orientation of the box in relation to the beach chair, safety-anchor, etc. However, in order to ensure easy and fast mounting of the box to the device in question, the fastening means may also be adapted to allow fastening of the box to the device in any orientation of the box in relation to the device.

As outlined above, it is a part of the invention to protect the safety-box against unnoticed removal by unauthorised persons by physically linking it to a hard-to-move object such as a sun-bed or a safety-anchor (see later). In another embodiment of the invention the safety-box is further protected against such unnoticed removal by equipping it with a theft-alarm. Such functionality can be provided by fitting the safety-box with for instance an electronic theft-alarm that sounds-out if the safety-box is substantially shaken or if its orientation in 3-dimensional space is altered. To facilitate the authorised removal of the safety-box, such as the collection at sun-set, the activity of the theft-alarm is controlled by an on/off switch which is accessible when, and only when, the safety-box is open.

It is a further object of the invention to provide a device, termed a safety-anchor, which is easy to install/uninstall for the user but very difficult to remove for un-authorised person without attracting significant attention thereby facilitating its use as a hard-to-move attachment point for a safety-box.

The safety-anchor is to be secured by fastening. Briefly, as shown in FIG. 4 the safety-anchor consists of a threaded tip and a multifunctional rod, which is connected through a gear-box which in one position transmits both clockwise and counter clockwise rotating movements of the multifunctional rod into the threaded tip and in another position decouples this transmission. In the transmitting position the user can thus easily fastener the safety-anchor firmly into the ground as well as remove it by rotating the multifunctional rod (using a loose installation-bar) whereas none of these operations are possible in the decoupled mode. Thus, once the safety-anchor has been firmly anchored into the ground it can be protected significantly against un-authorised removal by i) shifting the gear-box to the decoupled position using the gear handle which is located at the end of the multifunctional rod which is above ground and ii) locking the gear handle in such a way that it cannot be operated by an unauthorised person. As shown in FIGS. 6 and 7, such locking of the gear handle to prevent unauthorised removal of the safety-anchor can be achieved by for instance mounting a safety-box or by using a padlock.

To provide maximum protection against unauthorised removal of the safety-anchor, it is a particular aspect of the invention that the gear-box is located close to its tip thus requiring unauthorised persons to dig deep into the ground to reach a position on the safety-anchor from which the threaded tip (that anchors the safety-anchor into the ground) can be unfastenered.

A person-skilled in the art will appreciate that the described functionality of the safety-anchor can be obtained with a range of different designs, with rods and threaded tips varying greatly in length, thickness, radial diameter, number of threads on the tip, steepness and radial size of the tread, etc. all of which falls within the spirit of the invention. Also, the safety-anchors may be manufactured from a range of different materials such as plastics, polymers and metals or a mixture hereof.

The safety-anchor may be fastened into the ground in a manner similar to fastening of a regular bolt or fastener into a wall. The rod part may preferably be provided with fastener support means supporting the rotational insertion of the anchor, e.g. provided with a transverse handle member or a slot like in a slotted fastener. The fastener support means may e.g. be provided in a distal end of the rod, i.e. opposite the end that is attached to the threaded part.

The anchor is useful for securing a variety of objects and devices other than the safety-box. These include, but are not limited to, devices and items such as beach-umbrellas, game poles, bags, water-crafts, bicycles, motor cycles, fishing rods, guns and other weapons used in the field, tools and machinery used outdoor in workplaces, products on display at shows and outside shops, sculptures and pottery located in gardens, an animal, a lawnmower, or even for securing a car. Many of these objects are attractive objects to steal for thieves.

In a preferred embodiment of the invention, therefore, a safety-anchor is provided with attachment means for securing peripheral objects to the anchor, e.g. eyelets, hooks or other types of mounts useful for holding and/or securing one or more of such other devices and items. A person skilled-in-the-art will appreciate that a variety of different designs of the multifunctional rod can provide such functionalities which thus fall within the spirit of the inventions.

The rod and the tip may be divided into two pieces which are interconnected via an axial bearing so that the rod and the tip is allowed to rotate independently. Prior to the insertion of the anchor, the rotational joint is locked so that rotation of the rod is transferred to the threaded part. The locking may be performed by the insertion of a locking element into a rotationally locking engagement in the rod and in the threaded tip. The locking element thus function as a “grove and tongue” like coupling between the threaded tip and the rod.

Preferably, the rod is provided in the form of a hollow tube that houses the locking element and allows the element to move between a first position and a second position. In the first position, the element is disengaged with the treaded tip and in the second position, the locking element is in rotationally locking engagement with the treaded tip. When the element is allowed to move slidingly from the first to the second position or vice versa, the user is able to shift the anchor between a locked and an unlocked state for securing the anchor or for removing the anchor, respectively.

The anchor may further comprise a handle member arranged to control the moving of the locking element from the distal end of the rod, i.e. opposite the end where the rod is attached to the threaded tip. The handle member may advantageously be adapted to co-operate with fixating means allowing fixation of the locking element in any of the first and/or the second positions. The anchor may further comprise locking means adapted to receive a pad-lock for locking the locking element in one or either the first and the second positions.

In a particular aspect of the invention the two piece safety-anchor serves as the basic unit onto which other units can be mounted. For instance, the rod of the safety-anchor may carry a universal mount that allows a range of other units (that provide a range of different functionalities) to be readily attached—and locked to the safety-anchor.

In a special embodiment of the invention, the principle of the safety-anchor is exploited to provide novel safety-fasteners that overcome the difficulties and drawbacks of contemporary safety-fasteners. Specifically, the invention provides novel safety-fasteners that combine the attributes of ordinary fasteners with the ability to be converted into a safety-fastener by any of a number of very simple operations. Fasteners based on the invention can thus be mounted as ordinary fasteners using a variety of standard tools and, once mounting is satisfactory, turned into safety-fasteners that cannot be easily removed by unauthorised persons.

In a preferred embodiment, the safety-fastener of the invention consists of at least a rod and a threaded tip, which are interconnected in a joint that allows transmission of rotational movement from the rod to the threaded tip in one locked state (the operational state) and prevents such transmission in another unlocked state (the safety state).

In the operational state, the safety-fastener thus behave as ordinary fasteners that can be fastened or removed by either clockwise or counter-clockwise rotation using appropriate tools to apply torque to the fastener-head. Once the fastener is fastened satisfactory it can then be converted into a safety-fastener by switching to the safety state in which rotational movement between the rod and threaded tip is decoupled.

The ability to shift between an operational and a safety state can be provided by for instance designing the safety-fastener such that it contains a hollow channel that runs through the length of the rod and into the threaded tip and wherein a locking element can be inserted that—depending on its position in the channel—either couples (operational state) or decouples rotational transmission (safety state) between the two parts. The internal channel in the safety-fastener may be a square hole into which a locking element is inserted that has a cylindric shape at the proximal end (fastener-head end) and a square shape, which fits the square hole, at the distal end (threaded tip end). When the locking element is located such that its square section spans the joint between the rod and threaded tip the two section are rotationally locked and the safety-fastener is thus in the operational state. Conversely, when the square part of the locking element is located exclusively in either the rod or the threaded tip, or if it is completely removed from the safety-fastener, the rod and threaded tip are rotationally decoupled and the safety-fastener is thus in the safety state.

In one embodiment of the invention the safety-fastener is so designed that the locking element is accessible from the fastener-head end and such that the safety state is achieved by driving the locking element deeper into the safety-fastener (push-down Safety-fastener, see FIG. 8). Simultaneously with converting the fastener to a safety-fastener this action prevents the insertion of another locking element that could re-establish the rotational lock. Safety-fasteners of this design (irreversible safety-fasteners) are therefore extremely difficult to remove once the have been fastened which makes them ideally suited for securing valuables and other objects that are left unattended for extended periods of time.

In another embodiment of the invention, an irreversible safety-fastener is provided by designing the locking element such that it breaks when a pre-defined torque is applied to the fastener (torque safety-fastener, see FIG. 9). In this case, the internal channel that houses the locking element need only extend a little from the joint into the rod and threaded tip. By using different materials and sizes of locking elements, fasteners may be manufactured that converts into Safety-fasteners at a wide range of specifically applied forces. If materials such as plastic, polymer or a soft metal such as copper or lead, are used for the locking element the breaking process will start with a deformation and therefore be slow. In contrast, if the locking element is made of a ceramic or a hard metal, the breaking process will be sudden. The size of the force that is required to break the locking element can be displayed on the fastener in a number of ways such as for instance as a number that designates the required torque or a colour code. In a special design, the safety-fastener is supplied separately from the locking element thus allowing the user to decide the torque required for converting the fastener to a safety-fastener by choosing between a number of different locking elements. In this design the rotational joint is locked by insertion of the locking element into a slot that is accessible from the side of the safety-fastener.

In some cases it may be desirable that the safety-fastener can be shifted between the operational state and the safety state (reversible safety-fasteners) so that the user may remove the object secured by the safety-fastener by the same means that was used to fasten it. In a preferred embodiment of the invention the safety-fastener is therefore designed such that the safety state is achieved by removal of the locking element (pull-out safety-fastener, see FIG. 10). Holders of a correct locking element can thus always remove the safety-fastener by re-insertion of the locking element whereas persons that do not have a correct locking element cannot. To increase the security of this embodiment the channel in the safety-fastener and its corresponding locking element can be provided in a large number of different designs.

In another embodiment of reversible safety-fasteners, the rod carries a lock, which upon entry of a code or by the use of a key, enables shifting between the operational state and the safety state (see FIG. 11).

Safety-fasteners (like safety-anchors) based on the invention can have a range of different design thus providing many manufacturing options. FIG. 12 depicts a number of such designs. A person skilled-in-the-art, however, will appreciate that the functionality of the safety-fasteners according to the invention can be obtained with a variety of other designs which thus fall within the spirit of the invention. In one design, the rotational joint between the rod and threaded tip is a closed flanged joint (FIG. 12a). In this case, pushing the two matching parts together end-to-end assembles the safety-fastener. Optionally, such an assembly process may involve cooling the rod and heating the threaded tip or vice versa. Alternatively, as the rod and threaded tip cannot slide sideways relative to each other once the safety-fastener is mounted, the flanged joint between the rod and the threaded tip may also be open thus allowing easy side-to-side assembly (FIG. 12b).

The rod and the threaded tip may also be designed such that they are assembled by the use of a locking ring (FIG. 12c) or the rod and threaded tip may each carry a flange that enables end-to-end or side-by-side assembly via a separate connective part (FIG. 12d). The connective part may be made of a range of different materials, such as for instance plastics, polymers, metals etc. The flexible materials may be most suitable for manufacturing a connective part used for end-to-end assembly of the rod and threaded tip whereas non-flexible materials may be most suited for manufacturing a connective part used for side-to-side assembly of the rod and threaded tip.

The rod, the tip or both may be manufactured in more than one part. For instance, the rod may be manufactured in two parts that are assembled side-to-side together with the threaded tip (FIG. 12e). In this case, the two rod-halves may be held together by for instance matching flanges or one or more locking rings. Also, the rod and threaded tip may also be such that fastenering can assemble them. In this case, both halves carry a matching uni-directional thread that does not allow the two parts to be unfastened once assembled (FIG. 12f).

Depending on the intended application of the safety-fastener the rod may be longer or shorter than the threaded tip or of equal length, or the rod may or may not carry a part of the thread. Guidance for selecting the appropriate safety-fastener can be provided by realising that unauthorised removal of a fastened safety-fastener will require digging sufficiently deep into the material into which the safety-fastener was inserted to enable a rotational grip on the threaded tip. When safety-fasteners are used to install objects, such as for instance anti-burglar mounts on doors and windows, the metal mount itself significantly hamper the “digging” possibility thus facilitating the use of safety-fasteners with short rods and hence long threaded tips that provide powerful anchoring. Conversely, longer rods would be more useful when the safety-fastener is used to fasten objects in soft materials and/or to fasten objects that do not themselves provide protection against digging round the safety-fastener. In a preferred embodiment, a set of rods and threaded tips of different length and sizes are designed such that they can be combined freely and assembled easily by the user to suit the task at hand.

A variety of materials such as for instance plastics, polymers and metals may be used for manufacturing the safety-fastener of the invention and more than one material may be used in a safety-fastener. Likewise, the safety-fastener of the invention can be manufactured with all standard gripping means such as for instance the normal hexagonal blot heads for spanners and monkey wrenches, but also countersunk fastener-heads for Allen keys, ordinary fastener drivers, Parker's fastener drivers etc. Also, the principle of the invention applies equally well to all types of fasteners, e.g. screws, bolts, etc.

The principle of the invention i.e. a fastener that behaves as a normal fastener until converted into a safety-fastener by dislocating, removing or breaking an element that rotationally connects a rod and a threaded tip, applies equally well to very small fasteners as well as very large ones. Depending on the specific application the size of safety-fasteners may range from radial sizes of a few millimetres and lengths of a few centimetres to fasteners having a radial size of up to 0.25-0.5 meters and a length of several meters.

It is a further object of the invention to provide a device, termed a lock-safety-fastener, that consist of a fastener, such as for instance a screw, and a lock. The fastener comprises a region for anchoring it into a solid material e.g. a wall, a floor, etc., a lock-accepting region that enables the attachment of the lock and a means for mounting it such as for instance a fastener-head for applying torque to the fastener. When mounted in for instance a wall, the lock-accepting region protrudes from the wall and is thus accessible for attaching the lock.

The lock of the lock safety-fastener is constructed such that it
can be attached to the lock-accepting region of the fastener when unlocked
cannot be detached from the lock-accepting region of the fastener when locked,
can rotate freely on the lock-accepting region of the fastener when locked, and
prevents the lock-accepting region of the fastener and the fastener-head to be accessed by gripping tools when locked.

In a preferred embodiment, the fastener part of the lock-safety-fastener comprises a treaded region and a screw-head, such that it can be fastened or removed by either clockwise or counter-clockwise rotation using appropriate tools to apply torque to the screw-head. Once the fastener is satisfactory secured the object or device to be protected against unauthorised removal are then attached to the lock-accepting region followed by attachment and locking of the lock.

Once installed, the lock-safety-fastener thus facilitates easy attachment or removal of an object or device by the authorised user without the use of tools whilst at the same time protecting the object or device significantly against removal by unauthorised persons. As such, the lock-safety-fastener is particularly well suited for securing valuable items and devices, which typically have a fixed location but which the owner would want to be able to easily move on a regular basis without the use of any tools. These include, but are not limited to, devices and items such as computers, computer screens, printers, televisions, paintings, stereo equipment, loud speakers etc. that are typically located at fixed positions on floors, tables, walls etc. but which need to be removed occasionally for cleaning, repair, etc.

A person skilled in the art will appreciate that the described functionalities of both the fastener and lock can be obtained with a variety of designs and locking principles, which thus fall within the spirit of the invention.

In a preferred embodiment the lock is designed as a code lock, comprising from 2-12 numbered discs, preferably from 3 to 8 disks and most preferably from 3 to 5 discs. FIG. 13 depicts one such design. Briefly, the fastener part of the lock-safety-fastener comprises a threaded region that is separated from the lock-accepting region by a fixed disc that ensures that the fastener is inserted to the appropriate depth in the material. The lock-accepting region has a cylindric shape with one or more pegs and also comprises the fastener-head for applying torque to the fastener. The code lock comprises several numbered discs each of which carry a notch that is just large enough to allow the pegs to move through. When the correct code is entered, the notches align with the pegs on the lock-accepting region on the fastener, thus allowing the lock to be attached to, or removed from, the lock-accepting region of the fastener. Conversely, when incorrect codes are entered the pegs will position behind the solid part of the discs and thus prevent the code lock from being removed. Also, since the code-lock rotates freely on the locking region of the fastener the fastener cannot be removed by rotating the code-lock.

In a particular preferred embodiment, the code lock enables the owner of the lock to change the code. FIG. 14 shows an example on how such a code lock can be constructed. Briefly, the lock comprises a centre rod that holds alternating numbered discs and smaller discs, the latter of which each has a small part of their exterior removed to create an indent. The numbered discs engage the smaller discs such that when the numbered discs are rotated so are the smaller discs. Pressing against each of the smaller disks are spring-activated pins whose other end can protrude into a cylindrical cavity into which the lock-accepting region of the fastener can be inserted. The lock-accepting region of the fastener carries notches that spans its circumference and enables locking engagement with the part of the pins that can protrude into the cylindrical cavity. When the correct code is entered, the smaller discs are aligned such that the pins are opposite the indents. In this position the pins do not protrude into the cylindrical cavity and the lock can be detached from the fastener. When incorrect codes are entered the smaller discs forces the pins into locking engagement with the lock-accepting region of the fastener which can thus not be removed. To change the code, the correct code is entered and the centre rod that holds the numbered discs and the smaller discs are moved such that the numbered discs and smaller disks are disengaged. The numbered discs are then rotated to the desired new code after which the centre rod is moved back to re-establish locking engagement with the smaller discs.

In the most preferred embodiment, the code-lock is designed such that the user can code it and such that the locking region of the fastener is inserted into the centre of the lock. Briefly, as depicted in FIG. 15 the lock comprises 3 or 4 alternating numbered discs and smaller discs held in place by a lock-house which enables the numbered discs and small discs to both rotate and to slide in a longitudinal direction. Each of the smaller disks touches each other (with the last small disc pressing against a spring) and can slide through the numbered rings. Thus, when external pressure is applied to the first small disk it disengages from its cognate numbered ring and causes all the other small discs to disengage from their cognate numbered disks, thereby facilitating re-coding of the lock. Conversely, when pressure is released the spring pressing against the last small discs facilitates reengagement of the small discs and numbered discs. The smaller discs each have a notch that are just large enough to allow the pegs of the lock-accepting region of the fastener to move through. When the correct code is entered, the notches align with the pegs on the lock-accepting region on the fastener, thus allowing the lock to be attached to, or removed from, the lock-accepting region of the fastener. Conversely, when incorrect codes are entered the pegs will position behind the solid part of the small discs and thus prevent the removal of code lock and any object or devices secured by it.

In the above examples the lock is purely mechanical and have the disk combination type lock. Several other types of locks, however, are also possible including without limitation dial combination or push-button combination type locks, electrically powered code locks or key based locks.

In a typical situation, the fastener part of the lock-safety-fastener would be fastened into a wall, after which the device to be secured would be mounted on the protruding lock-accepting region of the fastener, followed by attachment of the lock. In some instances it may be possible to drill a hole in the device to be secured whereas in other cases it will not. In the latter cases a mount specifically designed for securing the particular type of item or device may be used.

To be broadly useful the lock-safety-fastener must be compatible with differences in material thickness of the various items and devices the owner wants to secure. As such, the gap size between the base of the mounted lock and the fixed disc on the fastener must on the one hand be large enough to accommodate different material thickness whilst on the other hand be small enough not to leave a portion of the lock-accepting region on the fastener exposed to handling by gripping means that could be used for unauthorised removal. One way of achieving this is to design the lock-safety-fastener such that a gap of for instance 1-2 cm exists between the base of the mounted lock and the fixed disc and to use spacer rings to fill up the gap after mounting of the device. A person skilled in the art will appreciate that other solutions exists which thus fall within the spirit of the invention.

A person skilled in the art will further appreciate that the lock-accepting region onto which the lock is attached may not be part of a fastener e.g. it may be any object which can be fastened to a wall, floor, table, etc. and display an accessible region that is compatible with the attachment of the lock.

In a preferred embodiment, the lock-safety-fastener is provided as a kit that comprises a number of fasteners of different sizes but with identical dimensions of the lock-accepting regions, a code lock and a set of spacer rings. A variety of materials such as for instance plastics, polymers and metals may be used for manufacturing the fastener part and code lock part of the lock-safety-fastener and more than one material may be used. Likewise, the fastener part of the lock-safety-fastener can be manufactured with all standard gripping means such as for instance the normal hexagonal blot heads for spanners and monkey wrenches, but also countersunk fastener-heads for Allen keys, ordinary fastener drivers, Parker's fastener drivers etc. Also, the principle of the invention applies equally well to other types of fasteners than fasteners, such as for instance bolts.

### THE DRAWINGS

For a fuller understanding of the nature and objects of the invention, reference is given to the following detailed disclosure and accompanying drawings, in which:

FIG. 1 shows a front and a side view of a possible design of a safety-box,

FIGS. 2A and B shows a back view of the safety-box of FIG. 5, as well as the safety-box mounted to a sun chair.

FIG. 3 shows a front and a side view of a possible design of a safety-box with an integrated mechanical code lock.

FIG. 4 shows a possible embodiment of a safety-anchor according to the invention.

FIG. 5 shows details of the gear-box of the safety-anchor shown in FIG. 4.

FIG. 6 shows details of the top part of the safety-anchor, shown in FIG. 4

FIG. 7 shows a top view of safety-anchor shown in FIG. 4 with an attached safety-box,

FIG. 8 shows a side view of a possible design of a push-down safety-fastener, i.e. an irreversible safety-fastener in which the switch between the operational and safety state is controlled by driving the locking pal into the safety-fastener.

FIG. 9 shows a side view of a possible design of two torque safety-fasteners, i.e. an irreversible safety-fastener that auto converts into a safety-fastener when a pre-determined torque is applied to the fastener.

FIG. 10 shows a side view of a possible design of pull-out safety-fastener, i.e. a reversible safety-fastener in which the switch between the operational and safety state is controlled by the removal/insertion of a locking element.

FIG. 11 shows a side view of a possible design of a reversible safety-fastener in which the switch between the operational and safety state is controlled by a code lock.

FIG. 12 shows a number of possible ways in which the threaded tip and rod can be designed to facilitate different manufacturing and assembly processes.

FIG. 13 shows a possible design of a simple lock-safety-fastener.

FIG. 14 shows details of a lock-safety-fastener, which enables the owner of the lock to change the code and wherein the code-lock is attached asymmetrically on the locking region of the fastener.

FIG. 15 shows details of a lock-safety-fastener, which enables the owner of the lock to change the code and wherein the code-lock is attached symmetrically on the locking region of the fastener.

FIGS. 16, 17 and 18 show side views of possible designs of a safety-fastener; in FIG. 17, the safety-fastener is shown in a coupled and in a decoupled situation.

### DETAILED DESCRIPTION OF THE INVENTION

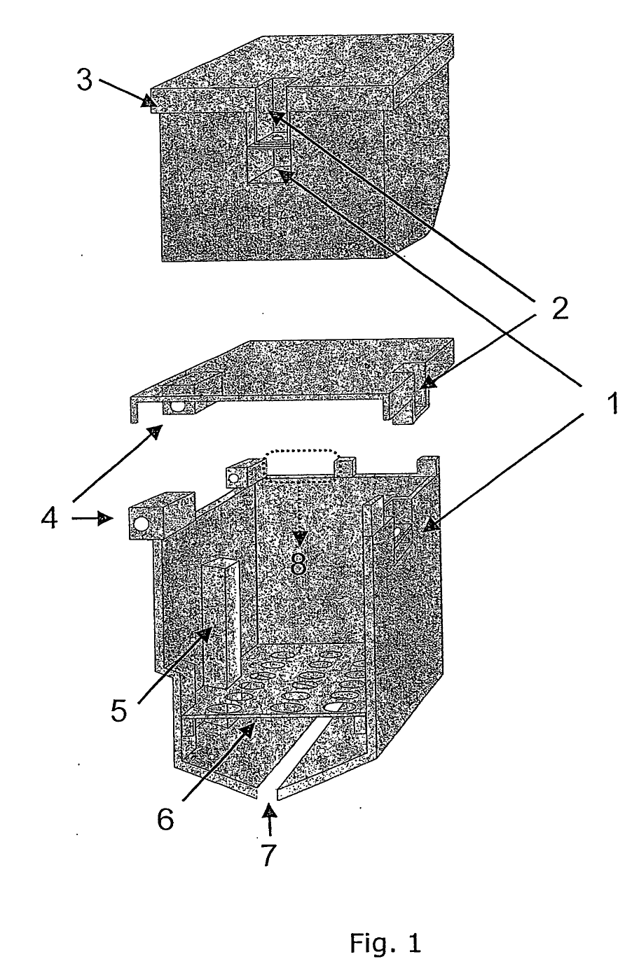

By referring to FIGS. 1-15, along with the following detailed disclosures, the construction and operation of the various safety-boxes, safety-anchors, safety-fasteners and lock-safety-fasteners according to the invention can be best understood. The drawings and the following detailed disclosure, fully discloses the present invention. However, the present invention can be implemented using alternate constructions which alternate constructions are therefore intended to be within the scope of the present invention.

FIG. 1 shows front and side view of a possible design of a safety-box to be used with a code padlock. Chamber part 1 of depressed eyelet for locking by a padlock, lid part 2 of depressed eyelet for locking by a padlock, lid overhang 3, hinges 4 that serves to connect the lid and chamber by insertion of a pin, groove 5 to accommodate mount, horizontal grid 6 that allows water and sand to pass through, slit 7 that drains water and sand that has accidentally entered the safety-box and air in-lets 8 protected by the overhanging lid.

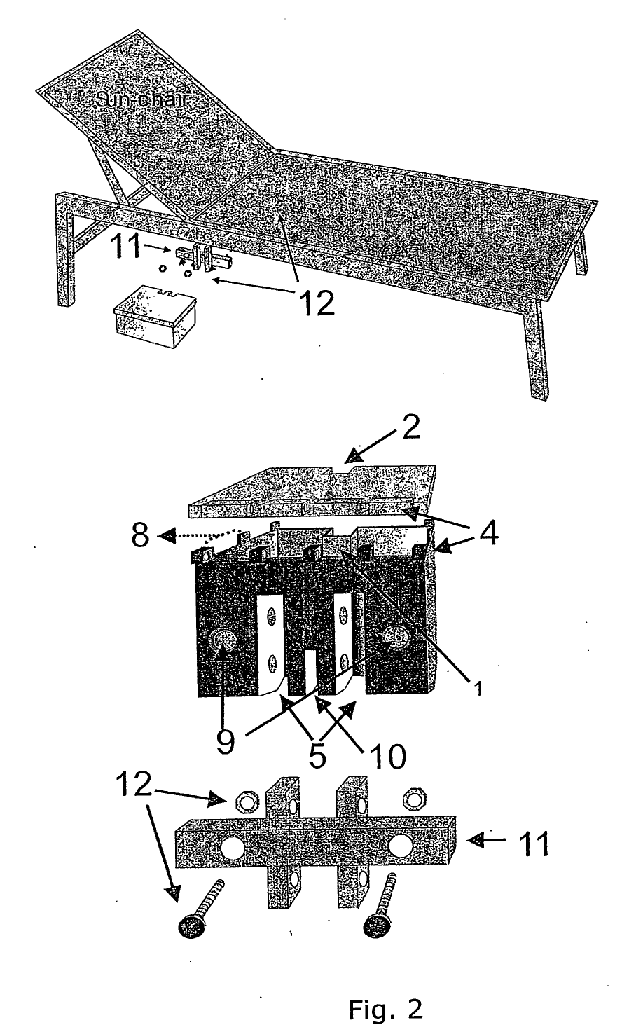

FIG. 2. Part A shows a possible attachment of the safety-box to a sun chair. In B, a back view of the safety-box of FIG. 1 and a possible design of a mount useful for attaching the safety-box to a sun-bed is shown. Hinges 4 that serves to connect the lid and chamber by insertion of a pin, Lid part 2 of depressed eyelet for locking by a padlock, air in-lets 8 protected by the overhanging lid, depressions 9 to accommodate nuts from mounting the safety-box on a sun-bed, grooves 5 to accommodate mount, groove 10 to immobilise handle for changing gear in the high position (decoupled position), chamber part 1 of depressed eyelet for locking by a padlock, mount 11 to attach the safety-box to a sun-bed and nuts and round-headed bolts 12 for attaching the mount on a sun-bed (bolts are inserted such that the mount cannot be dismounted when the safety-box is attached).

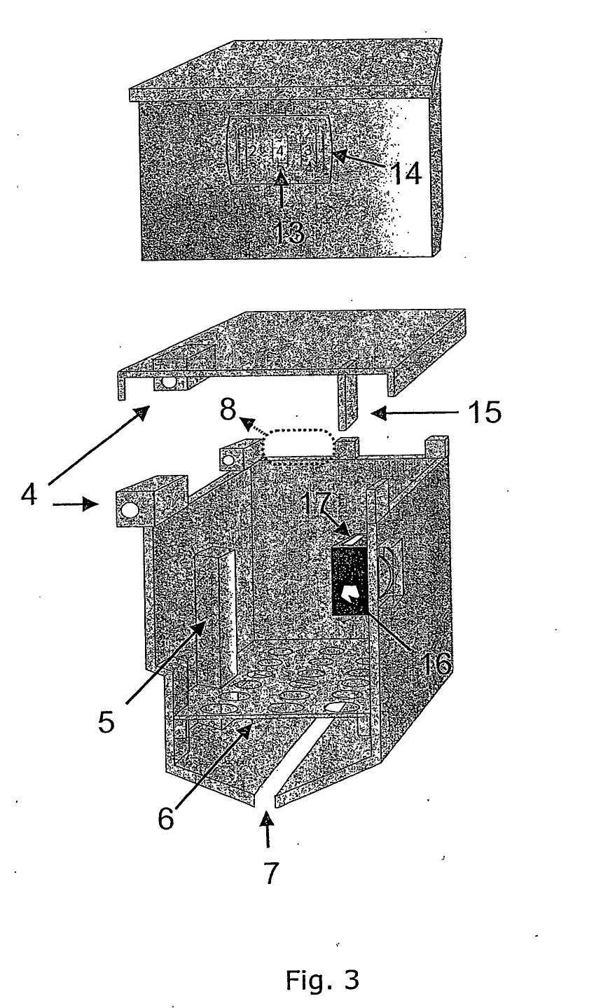

FIG. 3 shows front and side view of a possible design of a safety-box with an integrated mechanical code lock. 3-wheel mechanical code-lock 13, protective cover-lid 14 for code-lock, locking bolt 15, insertion point 16 for code-lock activating pin, insertion hole 17 for locking bolt, air in-lets 8 protected by the overhanging lid, hinges 4 that serves to connect the lid and chamber by insertion of a pin, groove 5 to accommodate mount, horizontal grid 6 that allows water and sand to pass through and slit 7 that drains water and sand that has accidentally entered the safety-box.

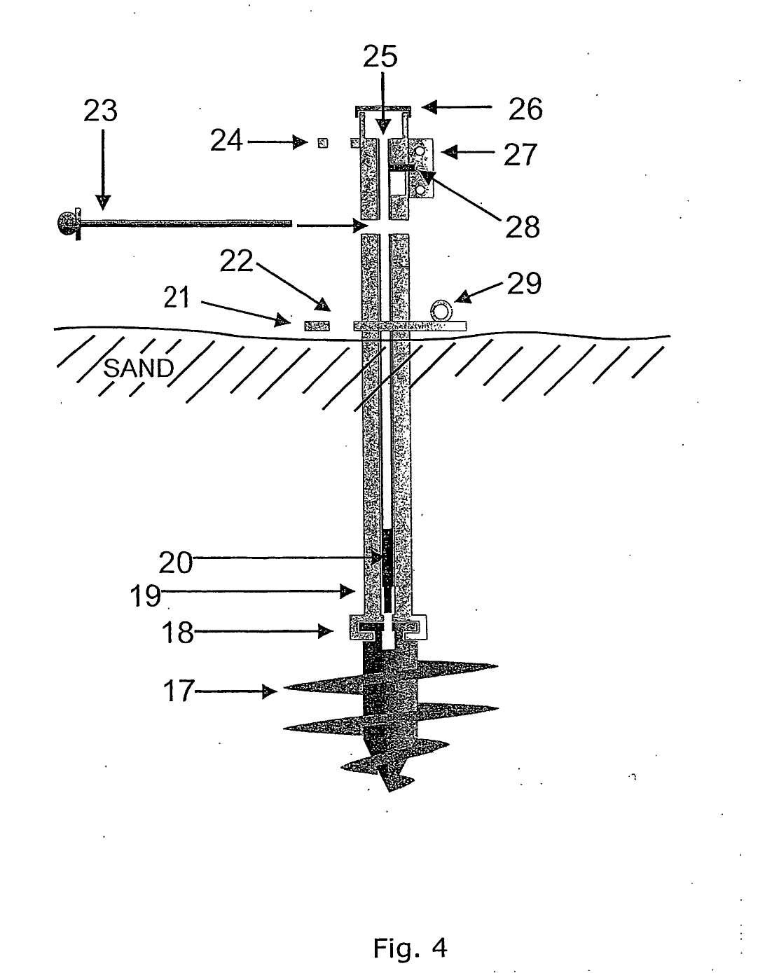

FIG. 4, shows a possible design of a multifunctional safety-anchor suitable for attaching a safety-box, a sun-parasol etc. may comprise a threaded tip 17 adapted to drive the safety-anchor into the ground and thus for fastening the Safety-anchor to the ground, a gear-box 18, a multifunctional rod 19, a gear-pin 20, a stop plate 21 to indicate when the safety-anchor has reached its correct depth and to stabilise the safety-anchor in a vertical position, a hole 22 to accommodate the rod of a sun-parasol (works in combination with the eyelet designated 8), a loose installation-bar 23 to enable a user to drive the safety-anchor into the ground, an eyelet 24 to accommodate the rod of a sun-parasol, a storage cavity 25 for the installation-bar, a fastener cap 26, mounts 27 for a safety-box, handle 28 for changing gear and an eyelet 29 for attaching bags, pets, etc to the safety-anchor.

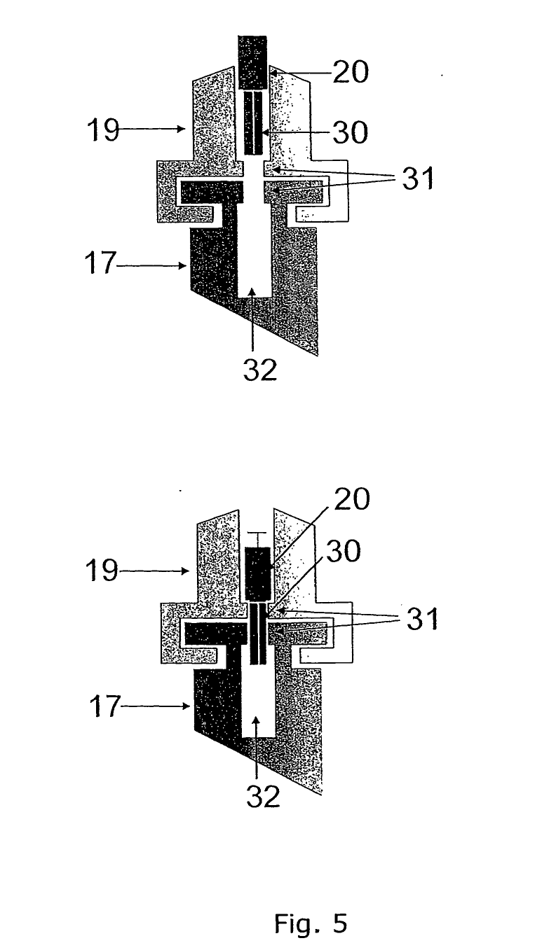

FIG. 5 shows details of the safety-anchor gear-box comprising the threaded tip 17, the multifunctional rod 19, the gear-pin 20 carrying a square tip 30, juxtaposed square holes 31 in the multifunctional rod 19 and threaded tip 17 to enable the square tip 30 of the gear-pin to interlock the two halves of the safety-anchor and a waste chamber 32 adapted to prevent small amounts of sand that accidentally gets into safety-anchor from blocking the action of the gear-pin 20. A: the gear-pin is in a “high” position—rotation of multifunctional rod does not transmit to the threaded tip. B: the gear-pin is in a “low” position—rotation of multifunctional rod does transmit to the threaded tip.

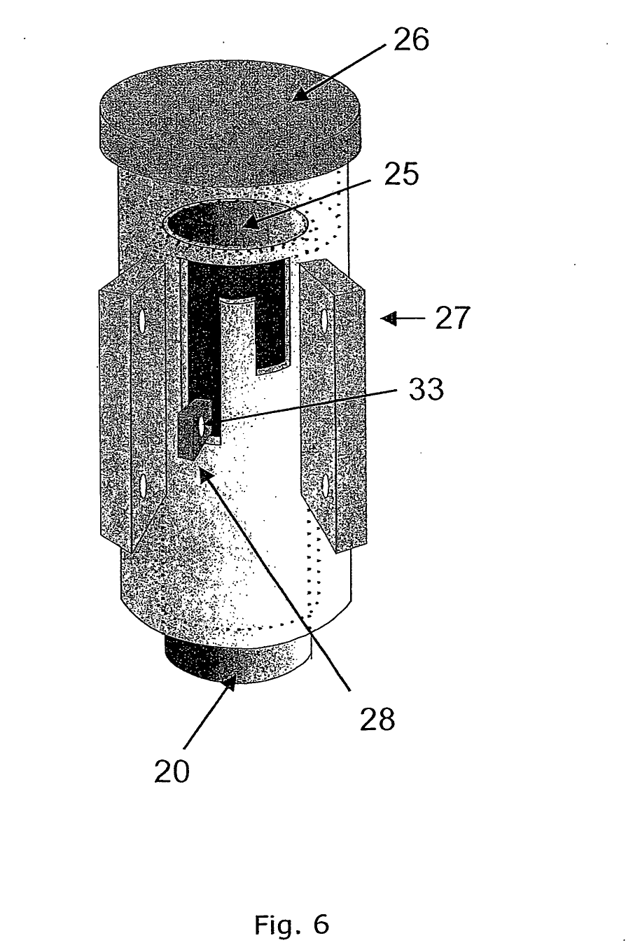

FIG. 6 shows details of the top part of the safety-anchor comprising gear-pin 20, handle 28 for changing gear, hole 33 in gear handle which, in combination with the upper hole in the safety-box mount, can be used to secure the gear-handle in the non-transmitting mode using a padlock (for securing the safety-anchor against unauthorised removal in cases where the safety-box is not mounted), mounts 27 for safety-box, storage hole 25 for installation-bar and fastener cap 26.

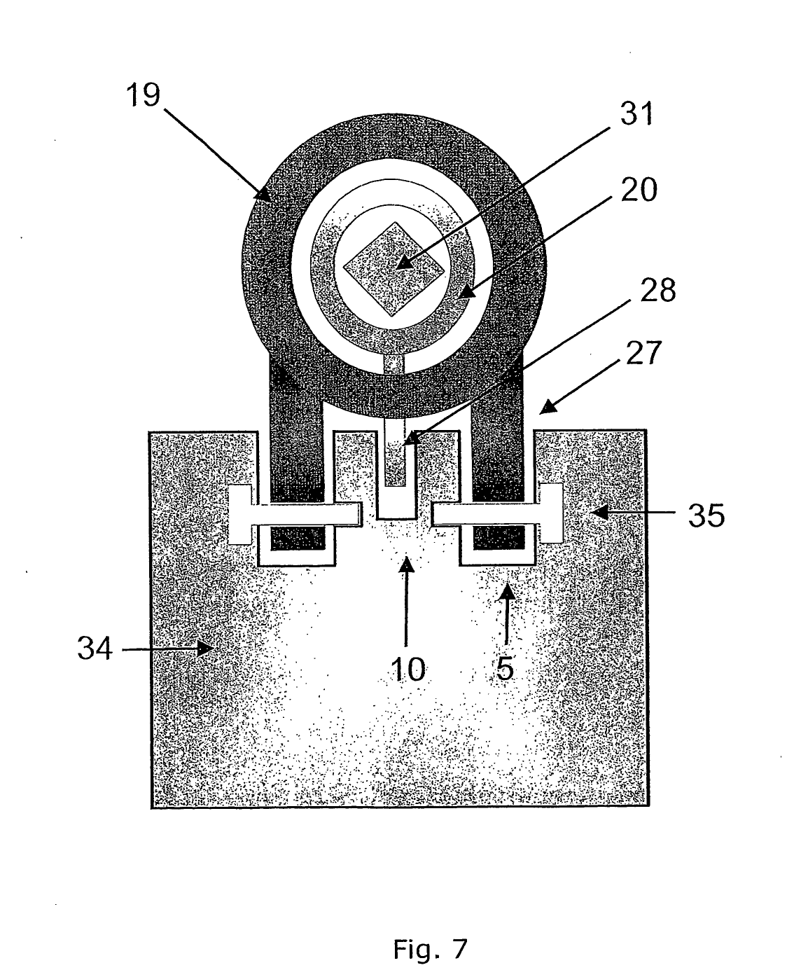

FIG. 7 shows top view of safety-anchor with attached safety-box. Safety-box 34, multifunctional rod 19 of safety-anchor, juxtaposed square holes 31 in multifunctional rod and threaded tip to enable the square tip of the gear-pin to interlock the two halves of the safety-anchor, Gear-pin 20, handle 28 for changing gear, mounts 27 for safety-box, bolts to fasten safety-box, grooves 5 to accommodate mounts and groove 10 to immobilise handle for changing gear in the high position (decoupled position).

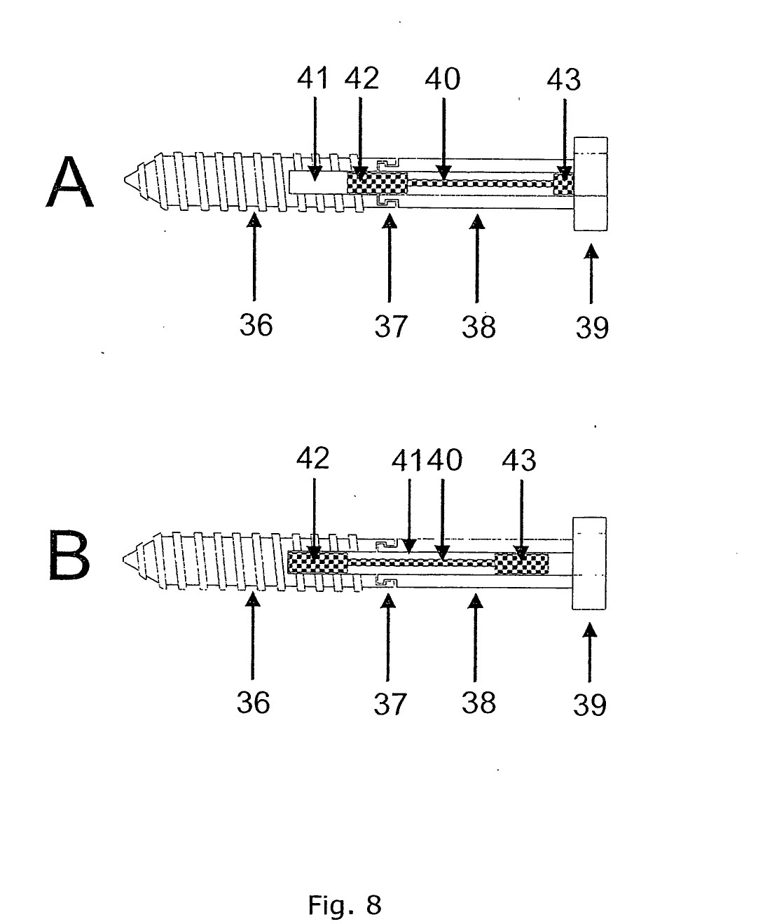

FIG. 8. Side view of a possible design of push-down safety-fastener. Threaded tip 36, a joint 37, a rod 38 carrying a fastener-head 39 which allows attachment of a device that facilitates rotational movements of the fastener, and a locking element 40 consisting of a middle section that can rotate freely in the locking channel 41 and a distal thickening 42 which fits the locking channel and enables rotational coupling/decoupling between the rod and the threaded tip and a proximal thickening 43 that fits the locking channel and serves to steer the locking element during movement and which is accessible from the fastener head. A: When the distal thickening is located across the joint between the rod and threaded tip, rotational force applied to the rod is transmitted to the threaded tip. B: The locking channel extends sufficiently deep into the threaded tip that it can accommodate the entire distal thickening of the locking element. Thus, when mounting of the safety-fastener is satisfactory, it can be secured against removal by applying a force to the proximal end of the locking element such that it is driven into the threaded tip, thereby decoupling rotational movement between the rod and threaded tip.

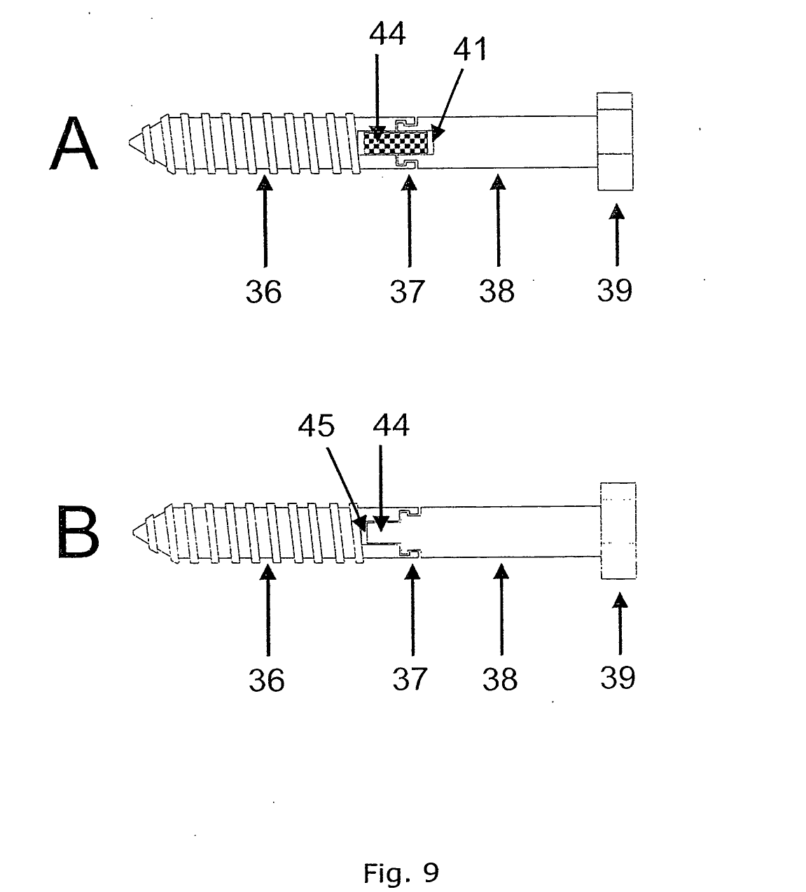

FIG. 9. Side view of a possible design of two torque safety-fasteners. A: The first fastener design comprises a threaded tip 36 a joint 37, a rod 38 carrying a fastener-head 39 which allows attachment of a device that facilitates rotational movements of the fastener and a torgue locking element 44 that fits the locking channel 41 and which locks the transmission of rational movement from the rod to the treaded tip and which breaks when a pre-determined torque is applied. B: The second fastener design comprises a threaded tip 36 a joint 37, a rod 38 carrying a fastener-head 39 which allows insertion of a device that facilitates rotational movements of the fastener and a torque locking element 44 which is an integral part of the rod that protrudes from its end and fits a matching cavity 45 in the threaded tip and which breaks when a pre-determined torque is applied.

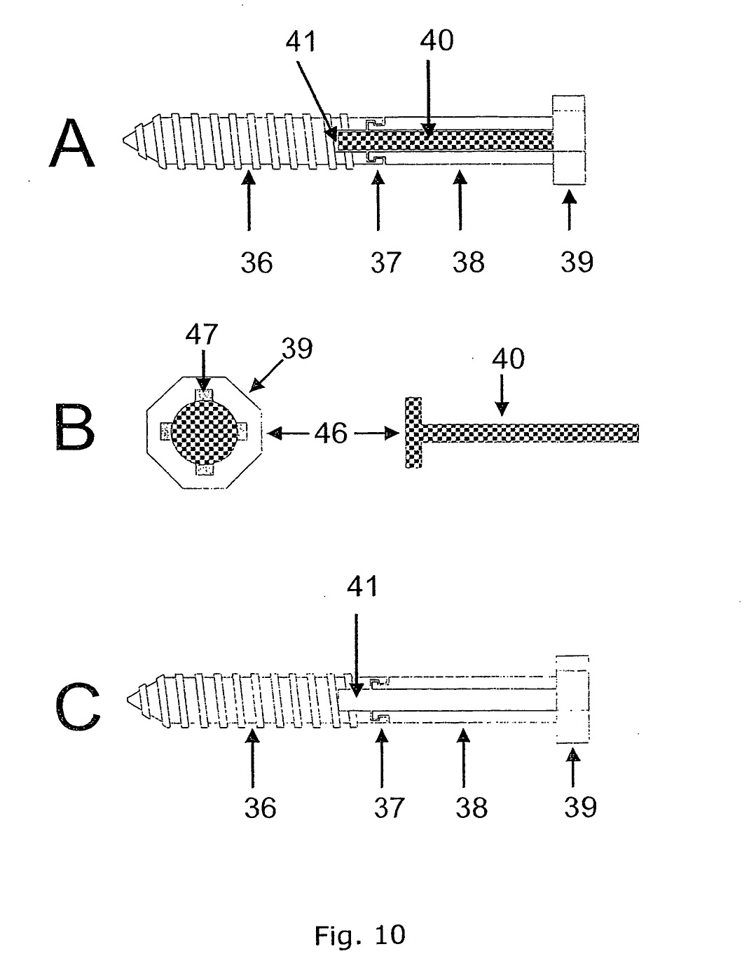

FIG. 10. Possible design of a pull-out safety-fastener. A: Side view of the pull-out safety-fastener comprising a threaded tip 36, a joint 37, a rod 38 carrying a fastener-head 39 which allows attachment of a device that facilitates rotational movements of the fastener, and a locking element 40 that fits the locking channel and couples rotational movement between the rod and the threaded tip and which has a head 46 that is accessible from the fastener head and allows it removal B: Top view of the fastener-head showing the head of the locking element 46 and grooves 47 which facilitates the removal of the locking element. C: Side view of the pull-out safety-fastener with the locking element removed to prevent unauthorised removal.

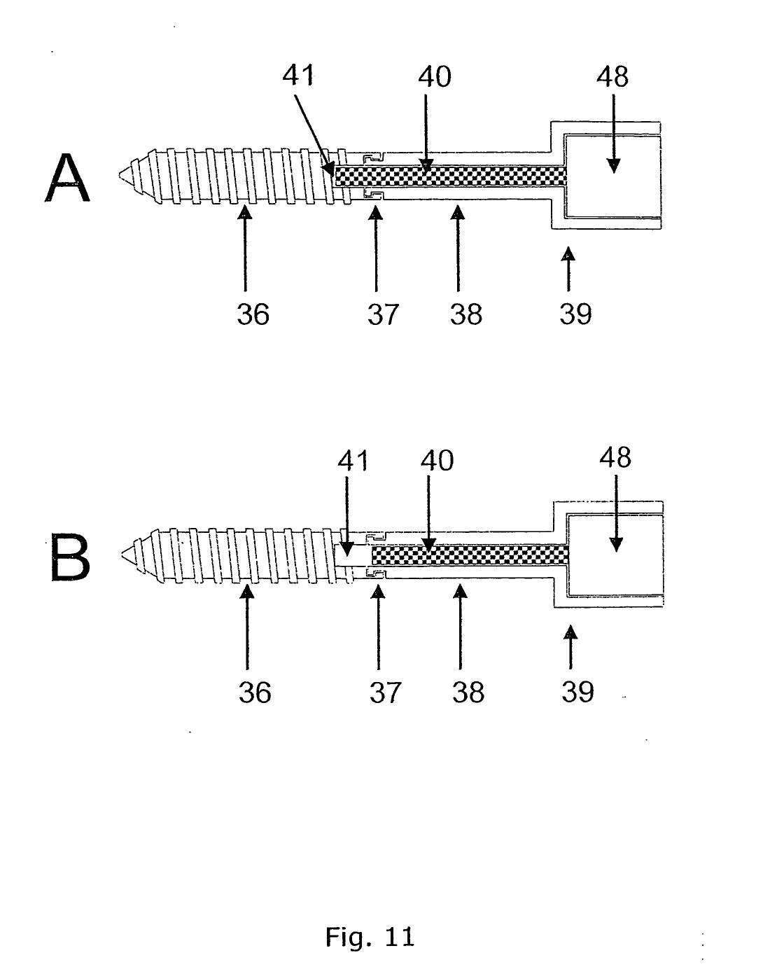

FIG. 11. Side view of a possible design of safety-fastener operated by a lock. Threaded tip 36, a joint 37, a rod 38 carrying a fastener-head 39 which allows attachment of a device that facilitates rotational movements of the fastener and contains the lock 48 which (upon insertion of for instance a key) serves to move the locking element 40 located in the locking channel 41 between a rotationally locked and unlocked position. A: Safety-fastener in the locked position where the locking element spans the joint between the rod and threaded tip. B: Safety-fastener in unlocked position where the locking element is located in the rod part of the Safety-fastener.

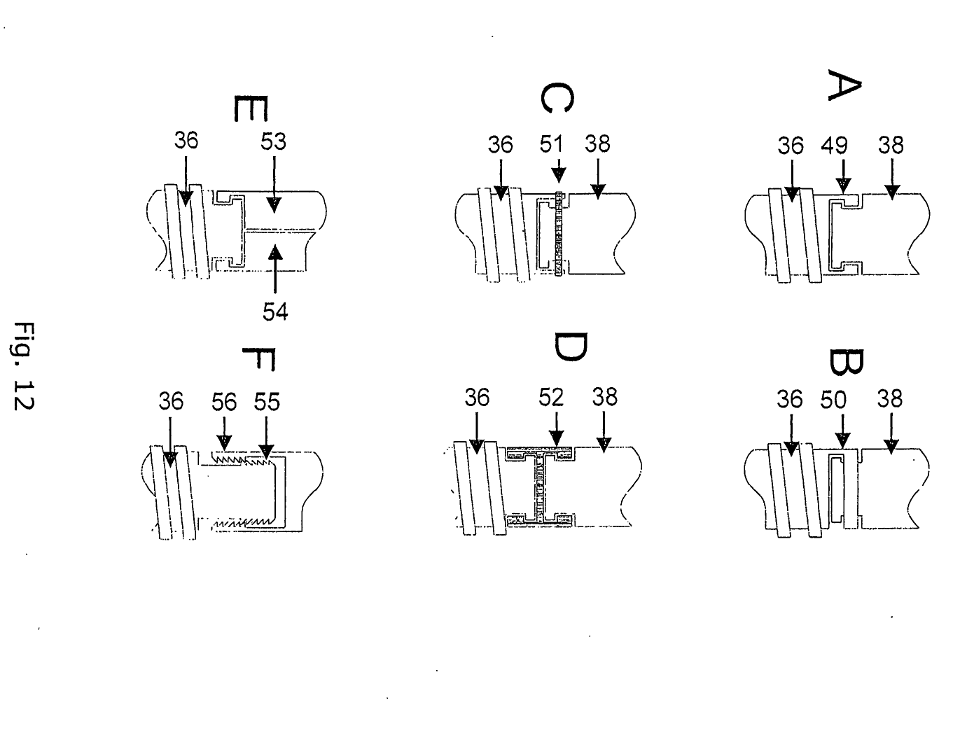

FIG. 12 shows a number of possible ways in which the threaded tip and rod can be designed to facilitate different manufacturing and assembly processes. A: threaded tip 36, closed flanged joint 49 for end-to-end assembly, rod 38. B: threaded tip 36, open flanged joint 50 for side-to-side assembly, rod 38. C: Threaded tip 36, open joint with locking ring 51 for end-to-end assembly, rod 38. D: Threaded tip 36, connective part 52 for end-to-end assembly of flanges on threaded tip and rod 38. E: threaded tip 36, first 53 and second 54 half of rod for sideways assembly around flange on threaded tip. F: Threaded tip 36 carrying unidirectional thread 55, which facilitates assembly (but not disassembly) by fastenering with rod 38 carrying matching unidirectional thread 56.

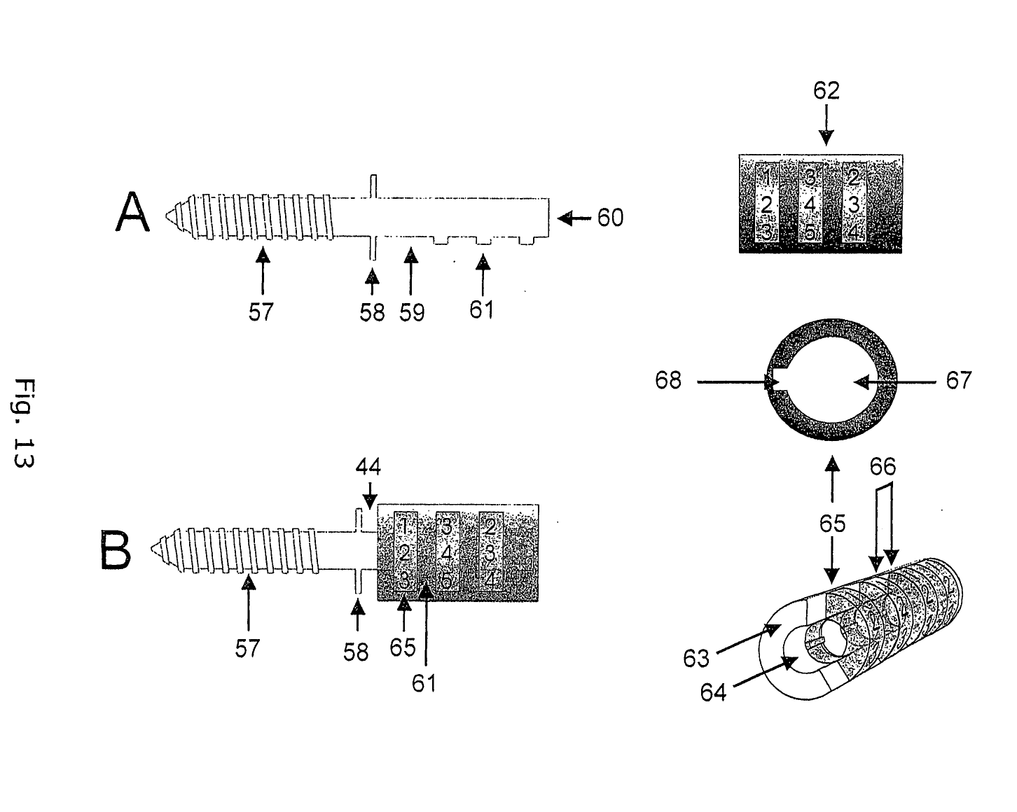

FIG. 13 shows a graphical representation of a possible design of a simple lock-safety-fastener. A: Threaded region 57, fixed disc 58, which ensures that the fastener is inserted to the correct depth in the material, and locking region 59 which carries the fastener head 60, which allows attachment of a device that facilitates rotational movements of the fastener, and one or more pegs 61 which serves as anchor point for the code lock 62. In its basic form the code lock consists of a central housing 63 comprising a channel 64 with a diameter slightly bigger than the outer diameter defined by the pegs on the locking region of the fastener, and one or more numbered rings 65 that have inter-disc distance 66 slightly bigger than the width of the pegs on the fastener. Each of the numbered rings have a circular hole 67 in their centre that fits the diameter of the fastener's locking region excluding the pegs, and a notch 68 behind one of the numbers that is just large enough to allow the pegs to move through. When the correct code is entered, the notches in the code lock align with the pegs on the locking region on the fastener, thus allowing the lock to be attached to, or removed from, the locking region of the fastener. Conversely, when incorrect codes are entered the pegs will position behind the solid part of the discs and thus prevent a mounted code lock from being removed. B: Fastener with attached code lock showing how the pegs 61 locate behind the numbered rings of the code lock once mounted. Also shown is the gap 69 between the base of the mounted code lock and the fixed disc of the fastener, which enables the lock-safety-fastener to be used with a range of different mounts and devices.

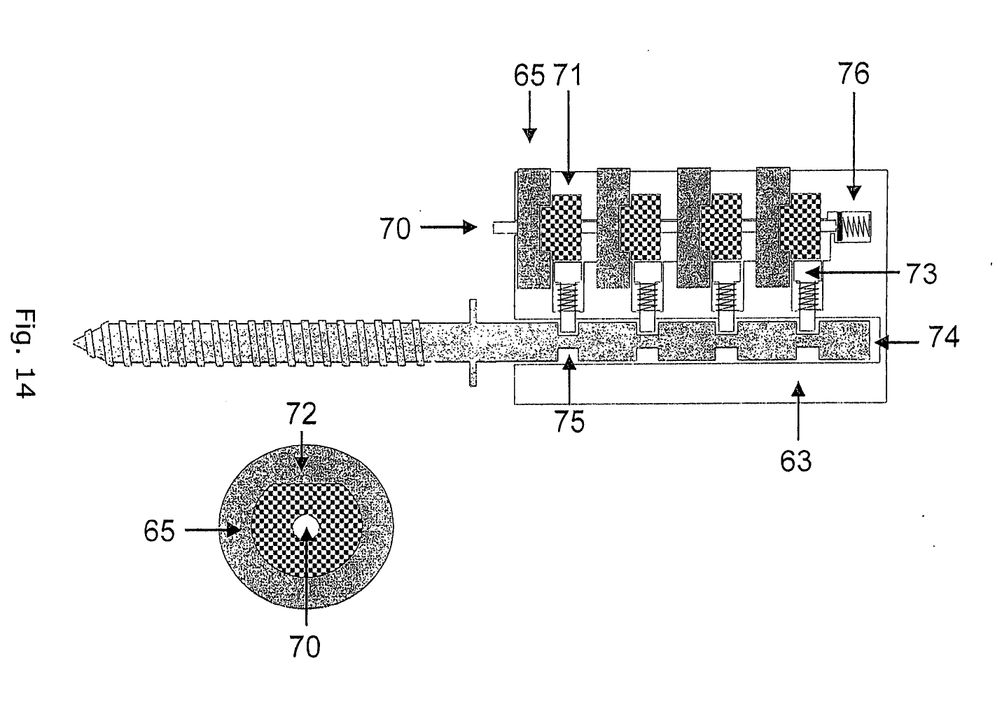

FIG. 14 shows an example of a lock-safety-fastener that can be programmed by the user and wherein the code-lock is attached asymmetrically on the locking region of the fastener. The lock comprises central housing 63 which holds a centre rod 70 onto which is mounted alternating numbered discs 65 and smaller discs 71 the latter of which each has a small part of their exterior removed to create an indent 72. The numbered discs engage the smaller discs such that when the numbered discs are rotated so are the smaller discs. Pressing against each of the smaller disks are spring-activated pins 73 whose other end can protrude into a cylindrical cavity 74 into which the locking region 35 of the fastener can be inserted. The locking region of the fastener carries notches 75 that spans its circumference and enables locking engagement with the part of the pins that can protrude into the cylindrical cavity. When the correct code is entered, the smaller discs are aligned such that the pins are opposite the indents. In this position the pins do not protrude into the cylindrical cavity and the lock can be detached from the fastener. When incorrect codes are entered the smaller discs forces the pins into locking engagement with the locking region of the fastener, which can thus not be removed. To change the code, the correct code is entered and the centre rod 70, which is in longitudinal (but riot rotational) lock with the smaller discs, is pressed inward against the bottom spring 76. This inward movement disengages the rotational lock between the numbered discs and smaller disks. The numbered discs can thus be rotated to a desired new code after which the centre rod is moved back to re-establish locking engagement with the smaller discs.

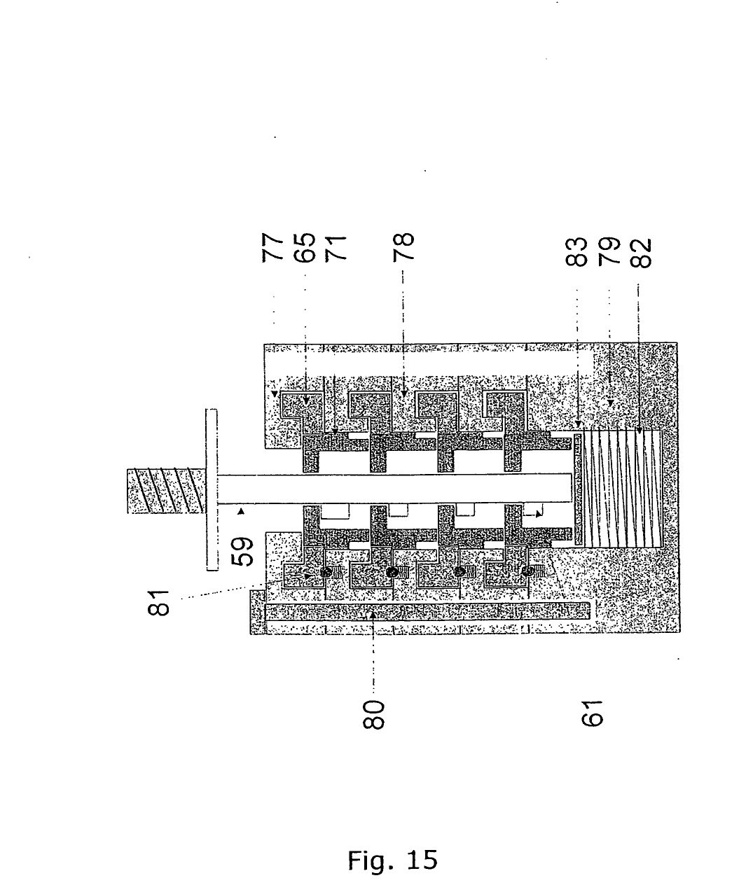

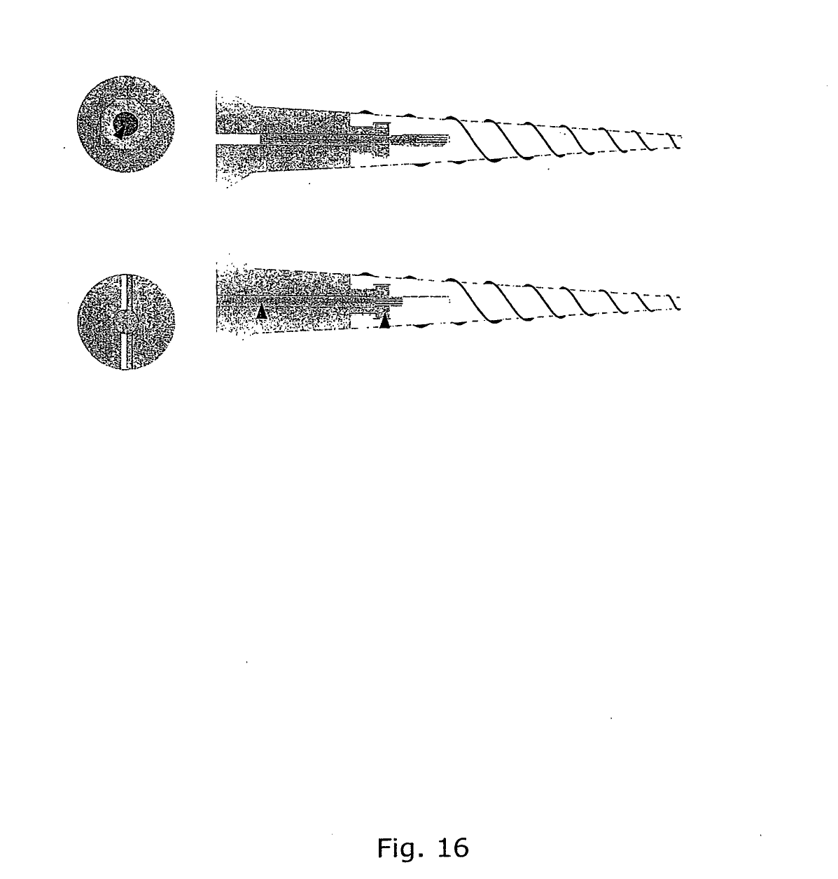

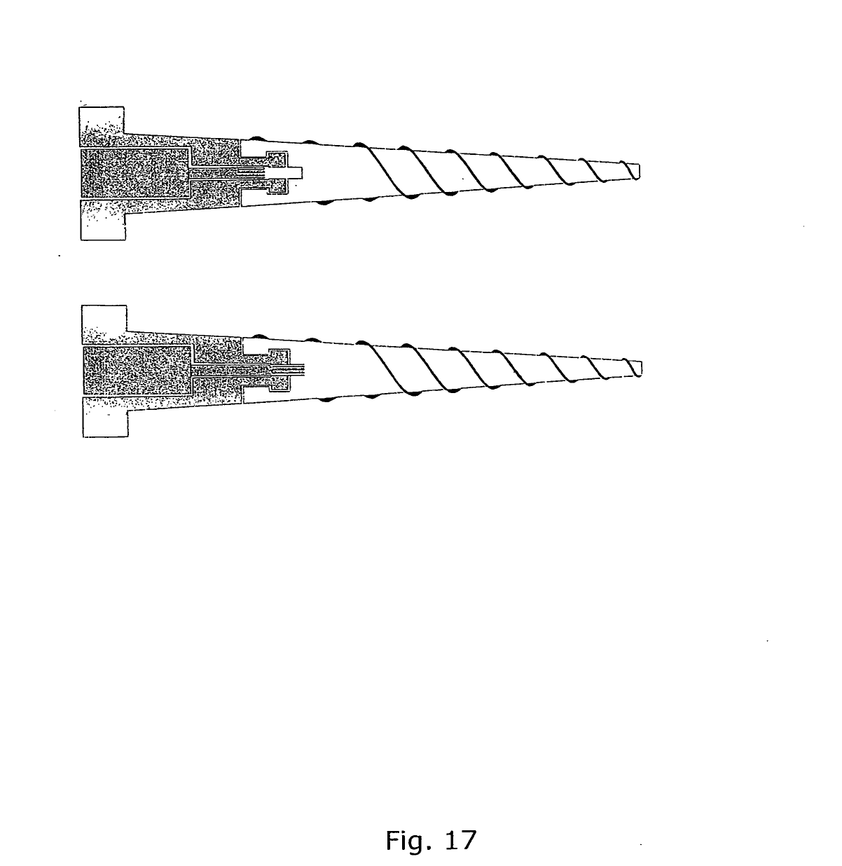

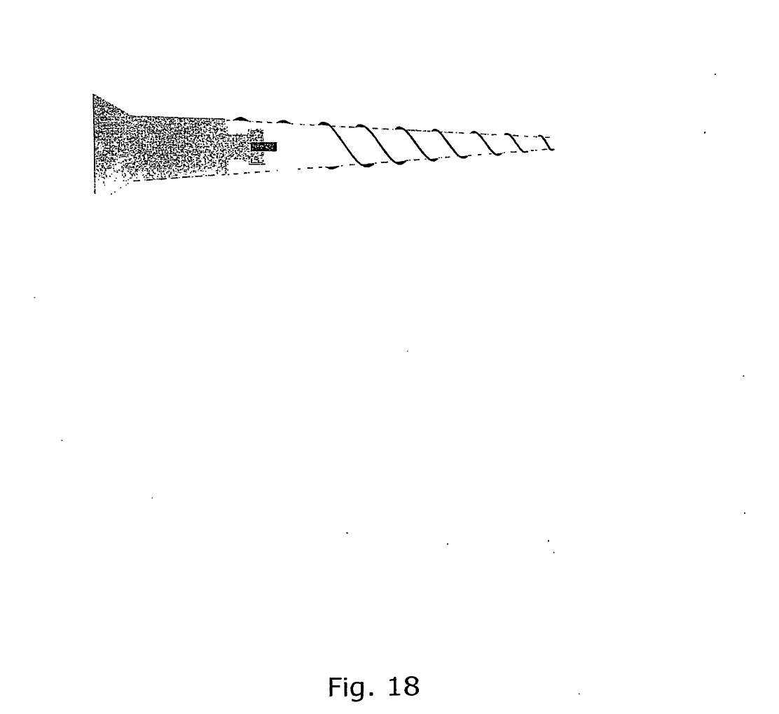

FIG. 15 shows an example of a lock-safety-fastener that can be programmed by the user and wherein the code-lock is attached symmetrically on the locking region of the fastener. A lock-house made up from a front-piece 77 three identical middle-pieces 78 and a back-piece 79 held together by fasteners 80 carries four numbered discs 65 and four small discs 71. The numbered discs can rotate freely and are click-positioned by small spring activated balls 81 that presses against indents in the numbered discs. The small discs can both rotate and slide in a longitudinal direction. The numbered discs engage the smaller discs such that when the numbered discs are rotated so are the smaller discs. Also, each of the smaller disks touches each other (with the last small disc pressing against a spring 82) and can travel through the numbered rings. Thus, when external pressure is applied to the first small disk in a longitudinal direction it disengages from its cognate numbered ring and causes all the other small discs to disengage from their cognate numbered disks, thereby facilitating re-coding of the lock. Conversely, when pressure is released the spring pressing against the last small discs facilitates reengagement of the small discs and numbered discs. External pressure can be supplied by a variety of means such as for instance through a hole in front-piece.

The front, middle and back pieces 77-79 that forms the lock-house are elliptical with the small diameter smaller than the outer diameter of the numbered rings 65 such that they can be handled by the user and with the large diameter sufficiently larger than the outer diameter of the numbered rings 65 to provide space for the fasteners 80 that are used to assemble the lock-house. The smaller discs 71 each have a notch that is just large enough to allow the pegs 61 of the lock-accepting region 59 of the fastener to move through. When the correct code is entered, the notches align with the pegs on the locking region on the fastener, thus allowing the lock to be attached to, or removed from, the locking region of the fastener. Conversely, when incorrect codes are entered the pegs will position behind the solid part of the small discs and thus prevent the code lock from being removed.

When the code-lock is manufactured in plastics or polymers it is preferred to insert a metal ring 83 either between the last small disc and the spring or in the bottom of the back piece to prevent thieves to easily access the fastener-head by drilling through the end of the back-piece.

Having described our invention, what we claim as new and desire to secure by Patent are:

1. A safety-fastener to be secured by fastening, said fastener comprising at least a threaded tip and a rod, the threaded tip and rod being interconnected in a joint allowing transmission of rotational movement from the rod to the threaded tip in one locked state and preventing transmission of rotational movement from the rod to the threaded tip in another unlocked state
wherein the joint and at least a part of the locking element is positioned at a distance below the surface of the structure to which the safety-fastener is fastened when in use.

2. A safety-fastener according to claim 1, being adapted to allow reversible shifting between the locked and the unlocked state.

3. A safety-fastener according to claim 1, wherein the joint is locked by the insertion of a locking element into a rotationally locking engagement in the rod and the threaded tip.

4. A safety-fastener according to claim 1, wherein the rod comprises a gripping means extending in a direction opposite to the threaded tip for applying a torque to the rod.

5. A safety-fastener according to claim 3, where the locking element is accessible from a top portion of the rod opposite to the threaded tip so as to allow shifting between the locked and the unlocked state on a mounted safety-fastener.

6. A safety-fastener according to claim 3, wherein the joint is shifted from the locked to the unlocked state and vice versa by the removal of the locking element from the joint.

7. A safety-fastener according to claim 3, wherein the joint is shifted from the locked state to the unlocked state by irreversible breaking of the locking element.

8. A safety-fastener according to claim 7, wherein the locking element is adapted to break at a pre-specified torque.

9. A safety-fastener according to claim 3, adapted to allow reversible shifting between the locked and the unlocked state by displacement of the locking element in the axial direction of the fastener.

10. A safety-fastener according to claim 9, wherein the locking element is displaced in a direction from the rod towards the threaded part.

11. A safety-fastener according claim 9, wherein the locking element is displaced in a direction from the threaded part towards the rod.

12. A safety-fastener according to claim 1, wherein the threaded part contains at least threads.

13. A safety-fastener according to claim 1, wherein the length of the threaded part is at least 50% of the entire length of the safety-fastener.

14. A safety-fastener according to claim 3, wherein the rod is provided in the form of a hollow tube that houses the locking element.

15. A safety-fastener according claim 3, wherein the rod and threaded tip comprises a hollow channel that houses the locking element.

16. A safety-fastener according to claim 15, further comprising a handle member arranged to control the moving of the locking element from a top portion, opposite the threaded tip, of the rod.

17. A safety-fastener according to claim 15, further comprising fixating means allowing fixation of the locking element in any of the first and/or the second positions.

18. A safety-fastener according to claim 1, further comprising locking means adapted to receive a pad-lock for locking the locking element in either the locked and/or the unlocked states of the fastener.

19. A safety-fastener according to claim 1, wherein the rod comprises attachment means for securing peripheral objects to the fastener.

20. A safety-fastener according to claim 19, wherein said object is selected from a group consisting of: a beach safety-box as defined herein, a beach-chair as defined herein, a parasol, a bike, a motor cycle, a boat, an animal, a fishing rod, a gun, a sculpture, a lawnmower, a garden pot and a car.

21. A safety-fastener according to claim 3, wherein the joint is shifted between the locked and unlocked state by respectively removing and inserting the locking element into the safety-fastener.

22. A lock safety-fastener comprising a fastener and a lock wherein the fastener contains
an insertion-region which can be used for attachment into a solid material, and
a lock-accepting region which protrudes from the solid material, and
wherein the attachment and locking of the lock to the lock-accepting region allows the lock to rotate freely around the lock-accepting region in its locked state thereby significantly hindering the possibility for loosening the fastener.

23. A lock safety-fastener according to claim 22, wherein the insertion-region of the fastener is threaded and wherein the lock-accepting region comprises a gripping means for applying torque to the fastener thereby enabling the fastener to be secured by screwing.

24. A lock safety-fastener according to claim 22, wherein the lock is constructed such that it
can be attached to the lock-accepting region of the fastener when unlocked
cannot be detached from the lock-accepting region of the fastener when locked,
can rotate freely on the lock-accepting region of the fastener when locked, and
prevents the lock-accepting region of the fastener and the fastener-head to be accessed by gripping tools when locked.

25. A lock safety-fastener according to claim 24, wherein the lock is a code-lock.

26. A lock safety-fastener according to claim 25, wherein the lock comprising from 2-12 numbered discs.

27. A lock safety-fastener according to claim 25, wherein the user can program the lock.

28. The use of a lock safety-fastener according to claim 22, to secure objects against unauthorized removal.
